(19) United States
(12) Patent Application Publication
(10) Pub. No.: US 2026/0160578 A1
(43) Pub. Date: Jun. 11, 2026

(54) METHOD AND APPARATUS FOR PROVIDING MAP INFORMATION AND SIGNAL INFORMATION BASED ON UNICAST OR GROUPCAST

(71) Applicant: LG Electronics Inc., Seoul (KR)

(72) Inventors: Jaihyun BYUN, Seoul (KR); Minsung KWAK, Seoul (KR)

(21) Appl. No.: 19/129,111

(22) PCT Filed: Nov. 15, 2023
(86) PCT No.: PCT/KR2023/018386

§ 371 Date: May 12, 2025

(30) Foreign Application Priority Data
Nov. 15, 2022 (KR) 10-2022-0152999

(51) Int. Cl. G01C 21/00; G08G 1/0968; H04W 4/40

(52) U.S. Cl. CPC G01C 21/3889; G08G 1/0968; H04W 4/40

(57) ABSTRACT

A method by which a first device performs wireless communication, and an apparatus for supporting same are provided. The method may comprise the steps of: receiving status information from a second device; determining, on the basis of the status information, a current driving route and a predicted driving route of the second device; selecting, on the basis of the current driving route and the predicted driving route, valid information related to the current driving route and the predicted driving route from information that the first device can provide; determining, on the basis of the current driving route and the predicted driving route, a transmission-related type of the valid information; and transmitting, on the basis of the determined transmission-related type, the valid information to the second device.

### TECHNICAL FIELD

This disclosure relates to a wireless communication system.

### BACKGROUND ART

Sidelink (SL) communication is a communication scheme in which a direct link is established between User Equipments (UEs) and the UEs exchange voice and data directly with each other without intervention of a base station. SL communication is under consideration as a solution to the overhead of a base station caused by rapidly increasing data traffic. Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

### DISCLOSURE

### Technical Solution

In one embodiment, provided is a method for performing wireless communication by a first device. The method may comprise: receiving, from a second device, state information; determining a current driving path and a predicted driving path of the second device, based on the state information; selecting valid information related to the current driving path and the predicted driving path, among providable information by the first device, based on the current driving path and the predicted driving path; determining a type related to a transmission of the valid information, based on the current driving path and the predicted driving path; and transmitting, to the second device, the valid information, based on the determined type related to the transmission.

In one embodiment, provided is a first device configured to perform wireless communication. The first device may comprise: at least one transceiver; at least one processor; and at least one memory connected to the at least one processor and storing instructions. For example, the instructions, based on being executed by the at least one processor, cause the first device to perform operations comprising: receiving, from a second device, state information; determining a current driving path and a predicted driving path of the second device, based on the state information; selecting valid information related to the current driving path and the predicted driving path, among providable information by the first device, based on the current driving path and the predicted driving path; determining a type related to a transmission of the valid information, based on the current driving path and the predicted driving path; and transmitting, to the second device, the valid information, based on the determined type related to the transmission.

In one embodiment, provided is a processing device configured to control a first device. The processing device may comprise: at least one processor; and at least one memory connected to the at least one processor and storing instructions. For example, the instructions, based on being executed by the at least one processor, cause the first device to perform operations comprising: receiving, from a second device, state information; determining a current driving path and a predicted driving path of the second device, based on the state information; selecting valid information related to the current driving path and the predicted driving path, among providable information by the first device, based on the current driving path and the predicted driving path; determining a type related to a transmission of the valid information, based on the current driving path and the predicted driving path; and transmitting, to the second device, the valid information, based on the determined type related to the transmission.

In one embodiment, provided is a non-transitory computer-readable storage medium recording instructions. For example, the instructions, based on being executed, cause a first device to perform operations comprising: receiving, from a second device, state information; determining a current driving path and a predicted driving path of the second device, based on the state information; selecting valid information related to the current driving path and the predicted driving path, among providable information by the first device, based on the current driving path and the predicted driving path; determining a type related to a transmission of the valid information, based on the current driving path and the predicted driving path; and transmitting, to the second device, the valid information, based on the determined type related to the transmission.

### BRIEF DESCRIPTION OF THE DRAWINGS

FIG. 1 shows a communication structure that can be provided in the 6G system, based on an embodiment of the present disclosure.

FIG. 2 shows an electromagnetic spectrum, based on an embodiment of the present disclosure.

FIG. 3 shows a scenario where an RSU provides ITS services at an intersection.

FIG. 4 shows an infrastructure services within an ITS station (ITS-S) structure.

FIG. 5 shows a method for a service provider to directly/indirectly identify necessary information of a road user.

FIG. 6 shows a method for a service provider to provide a service using a publish/subscribe model structure.

FIG. 7 shows an operation of a road side unit (RSU) providing road and lane topology (RLT) and traffic light maneuver (TLM) services at an intersection, based on an embodiment of the present disclosure.

FIG. 8 shows an operation of providing map information to a receiver when an RSU knows the driving path of the receiver, based on an embodiment of the present disclosure.

FIG. 9 shows a flowchart of an operation for providing map information and signal information using unicast or groupcast, based on an embodiment of the present disclosure.

FIG. 10 shows a flowchart of an operation for providing a service related to a MAPEM message with a publish/subscribe model structure, based on an embodiment of the present disclosure.

FIG. 11 shows a flowchart of an operation for providing a service related to a SPATEM message with a publish/subscribe model structure, based on an embodiment of the present disclosure.

FIG. 12 shows a method for performing wireless communication by a first device, based on an embodiment of the present disclosure.

FIG. 13 shows a method for performing wireless communication by a second device, based on an embodiment of the present disclosure.

FIG. 14 shows a communication system 1, based on an embodiment of the present disclosure.

FIG. 15 shows wireless devices, based on an embodiment of the present disclosure.

FIG. 16 shows a signal process circuit for a transmission signal, based on an embodiment of the present disclosure.

FIG. 17 shows another example of a wireless device, based on an embodiment of the present disclosure.

FIG. 18 shows a hand-held device, based on an embodiment of the present disclosure.

FIG. 19 shows a vehicle or an autonomous vehicle, based on an embodiment of the present disclosure.

### MODE FOR INVENTION

In the present disclosure, “A or B” may mean “only A”, “only B” or “both A and B.” In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, ‘when, if, or in case of’ may be replaced with ‘based on’.

A technical feature described individually in one figure in the present disclosure may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

The 6G (wireless communication) system is aimed at (i) very high data rates per device, (ii) a very large number of connected devices, (iii) global connectivity, (iv) very low latency, (v) lower energy consumption for battery-free IoT devices, (vi) ultra-reliable connectivity, and (vii) connected intelligence with machine learning capabilities. The vision of the 6G system can have four aspects: intelligent connectivity, deep connectivity, holographic connectivity, and ubiquitous connectivity, and the 6G system can satisfy the requirements as shown in Table 1 below. In other words, Table 1 is an example of the requirements of a 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

6G systems can have key elements such as enhanced mobile broadband (eMBB), ultra-reliable low latency communications (URLLC), massive machine-to-machine communications (mMTC), AI-integrated communications, tactile internet, high throughput, high network capacity, high energy efficiency, low backhaul and access network congestion, and enhanced data security.

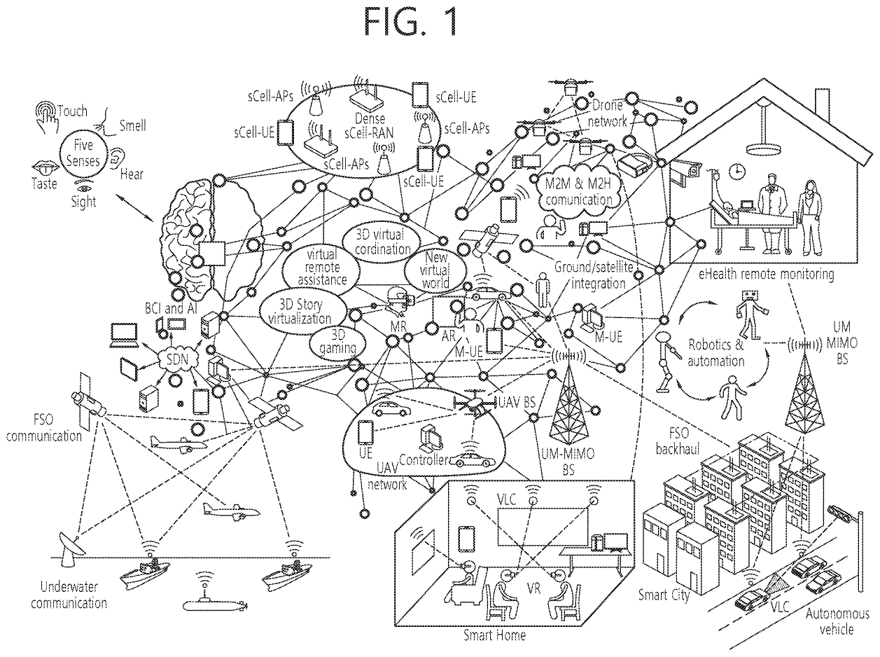

FIG. 1 shows a communication structure that can be provided in the 6G system, based on an embodiment of the present disclosure. The embodiment of FIG. 1 may be combined with various embodiments of the present disclosure.

6G systems are expected to have 50 times higher simultaneous radio connectivity than 5G radio systems. URLLC, a key feature of 5G, will become a more dominant technology in 6G communications, providing end-to-end delay of less than 1 ms. 6G systems will have much better volumetric spectral efficiency as opposed to the more commonly used area spectral efficiency. 6G systems will be able to offer very long battery life and advanced battery technologies for energy harvesting, so mobile devices will not need to be charged separately in a 6G system. New network characteristics in 6G may include the following.
Satellites integrated network: In order to provide a global mobile population, 6G is expected to be integrated with satellites. The integration of terrestrial, satellite, and airborne networks into a single wireless communication system is critical to 6G.
Connected intelligence: Unlike previous generations of wireless communication systems, 6G is revolutionary and will update the wireless evolution from “connected things” to “connected intelligence”. AI can be applied at each step of the communication process (or each step of signal processing, as we will see later).
Seamless integration wireless information and energy transfer: 6G wireless networks will transfer power to charge the batteries of devices such as smartphones and sensors. Therefore, wireless information and energy transfer (WIET) will be integrated.
Ubiquitous super 3D connectivity: Access to networks and core network functions from drones and very low Earth orbit satellites will make super 3D connectivity ubiquitous in 6G.

From the above new network characteristics of 6G, some common requirements may include.
Small cell networks: The idea of small cell networks was introduced in cellular systems to improve the received signal quality as a result of improved throughput, energy efficiency, and spectral efficiency. As a result, small cell networks are an essential characteristic for 5G and beyond 5G (5 GB) communication systems. Therefore, 6G communication systems will also adopt the characteristics of small cell networks.
Ultra-dense heterogeneous network: Ultra-dense heterogeneous networks will be another important characteristic of 6G communication systems. Multi-tier networks composed of heterogeneous networks will improve overall QoS and reduce costs.
High-capacity backhaul: Backhaul connectivity is characterized by high-capacity backhaul networks to support large volumes of traffic. High-speed fiber optics and free-space optics (FSO) systems can be a possible solution to this problem.
Radar technology integrated with mobile technology: High-precision localization (or location-based services) through communication is one of the features of 6G wireless communication systems. Therefore, radar systems will be integrated with 6G networks.
Softwarization and virtualization: Softwarization and virtualization are two important features that are fundamental to the design process in a 5 GB network to ensure flexibility, reconfigurability, and programmability. In addition, billions of devices may be shared on a shared physical infrastructure.

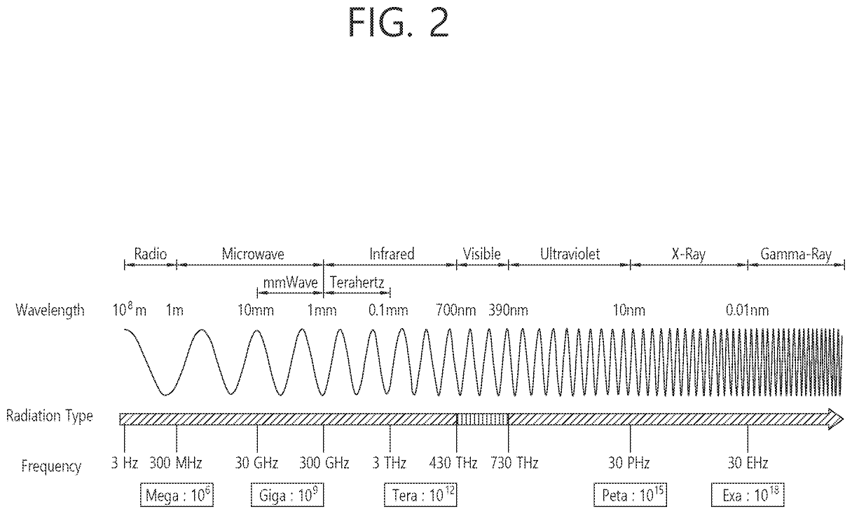

The following describes the key enabling technologies for 6G systems.
Artificial Intelligence: The most important and new technology to be introduced in the 6G system is AI. The 4G system did not involve AI, 5G systems will support partial or very limited AI. However, 6G systems will be AI-enabled for full automation. Advances in machine learning will create more intelligent networks for real-time communication in 6G. The introduction of AI in telecommunications can streamline and improve real-time data transfer. AI can use numerous analytics to determine how complex target tasks are performed, meaning AI can increase efficiency and reduce processing delays. Time-consuming tasks such as handover, network selection, and resource scheduling can be done instantly by using AI. AI can also play an important role in M2M, machine-to-human, and human-to-machine communications. In addition, AI can be a rapid communication in Brain Computer Interface (BCI). AI-based communication systems can be supported by metamaterials, intelligent structures, intelligent networks, intelligent devices, intelligent cognitive radios, self-sustaining wireless networks, and machine learning.
THz Communication (Terahertz Communication): Data rates can be increased by increasing bandwidth. This can be accomplished by using sub-THz communication with a wide bandwidth and applying advanced massive MIMO technology. THz waves, also known as submillimeter radiation, refer to frequency bands between 0.1 and 10 THz with corresponding wavelengths typically ranging from 0.03 mm-3 mm. The 100 GHz-300 GHz band range (Sub THz band) is considered the main part of the THz band for cellular communications. Adding the Sub-THz band to the mmWave band increases the capacity of 6G cellular communications. Of the defined THz band, 300 GHz-3 THz is in the far infrared (IR) frequency band. The 300 GHz-3 THz band is part of the optical band, but it is on the border of the optical band, just behind the RF band. Thus, the 300 GHz-3 THz band exhibits similarities to R.F. FIG. 2 illustrates an electromagnetic spectrum, according to one embodiment of the present disclosure. The embodiment of FIG. 2 may be combined with various embodiments of the present disclosure. Key characteristics of THz communications include (i) widely available bandwidth to support very high data rates, and (ii) high path loss at high frequencies, for which highly directive antennas are indispensable. The narrow beamwidth produced by highly directive antennas reduces interference. The small wavelength of THz signals allows a much larger number of antenna elements to be integrated into devices and BSs operating in this band. This enables the use of advanced adaptive array techniques that can overcome range limitations.
Large-scale MIMO Technology (Large-scale MIMO)
Hologram Beamforming (HBF, Hologram Bmeaforming)
Optical wireless technology
Free-space optical transmission backhaul network (FSO Backhaul Network)
Non-Terrestrial Networks (NTN)
Quantum Communication
Cell-free Communication
Integration of Wireless Information and Power Transmission
Integration of Wireless Communication and Sensing
Integrated Access and Backhaul Network
Big data Analysis
Reconfigurable Intelligent Surface (Reconfigurable Intelligent Surface)
Metaverse
Block-chain
Unmanned aerial vehicles (UAVs): Unmanned aerial vehicles (UAVs) or drones will be an important component of 6G wireless communications. In most cases, high-speed data wireless connectivity will be provided using UAV technology. BS entities are installed on UAVs to provide cellular connectivity. UAVs have certain features not found in fixed BS infrastructure, such as easy deployment, strong line-of-sight links, and controlled degrees of freedom for mobility. During emergencies, such as natural disasters, the deployment of terrestrial telecom infrastructure is not economically feasible and sometimes cannot provide services in volatile environments. UAVs can easily handle these situations. UAVs will be a new paradigm in wireless communications. This technology facilitates the three basic requirements of wireless networks, which are eMBB, URLLC, and mMTC. UAVs can also support many other purposes such as enhancing network connectivity, fire detection, disaster emergency services, security and surveillance, pollution monitoring, parking monitoring, accident monitoring, etc. Therefore, UAV technology is recognized as one of the most important technologies for 6G communications.
Autonomous Driving (Autonomous Driving, Self-driving): For complete autonomous driving, vehicle-to-vehicle communication is required to inform each other of dangerous situations, and vehicle-to-vehicle communication with infrastructure such as parking lots and traffic lights is required to check information such as the location of parking information and signal change times. Vehicle to Everything (V2X), a key element in building an autonomous driving infrastructure, is a technology that enables vehicles to communicate and share information with various elements on the road, such as vehicle-to-vehicle (V2V) and vehicle-to-infrastructure (V2I) wireless communication, in order to perform autonomous driving. In order to maximize the performance of autonomous driving and ensure high safety, fast transmission speeds and low latency technologies are essential. In addition, in the future, autonomous driving will go beyond delivering warnings or guidance messages to the driver to actively intervene in vehicle operation and directly control the vehicle in dangerous situations, so the amount of information that needs to be transmitted and received will be vast, and 6G is expected to maximize autonomous driving with faster transmission speeds and lower latency than 5G.

For clarity of description, 5G NR is mainly described, but the technical idea according to an embodiment of the present disclosure is not limited thereto. Various embodiments of the present disclosure may also be applied to a 6G communication system.

Meanwhile, according to prior arts, the intelligent transportation system (ITS) service may mean that transportation infrastructure (e.g., road side unit (RSU), signal system, road status board, central management server, multi-access edge computing (MEC), etc.) provides various information (e.g., traffic volume information, signal information, map information, road signs, road construction information, etc.) to road users (e.g., vehicles, pedestrians, etc.), and the ITS service may improve the safety of road users and traffic flow. Moreover, with development of wireless communication technology, ITS service may be provided to road users by utilizing vehicle to everything (V2X) communication technology. Meanwhile, as prior arts of the present disclosure, transport infrastructure such as RSUs or ITS servers may provide ITS services to road users by utilizing V2X communication technologies, i.e., short-range communication (e.g., Dedicated Short-Range Communication (DSRC), PC5) or long-range communication (e.g., Uu interface). In this case, for example, representative ITS services may include the Traffic Light Maneuver (TLM) service that provides traffic signal information, the Road and Lane Topology (RLT) service that provides road and lane information, and the Infrastructure to Vehicle Information (IVI) service that provides road sign information. For example, ITS service provider (e.g., RSU or ITS server) of the transportation infrastructure may transmit all information of the corresponding area to the receiver in a V2X message (MAP, SPaT (Signal Phase and Timing), RGA (Road Geometry and Attributes), TSPaT (Traffic Signal Phase and Timing), IVI (Infrastructure to Vehicle Information), TIM (Traveler Information Message), DENM (Decentralized Environmental Notification Message), RSA (Road Side Alert), RSM (Road Safety Message), RWM (Road Weather Message), etc.) regardless of the state of the receiver.

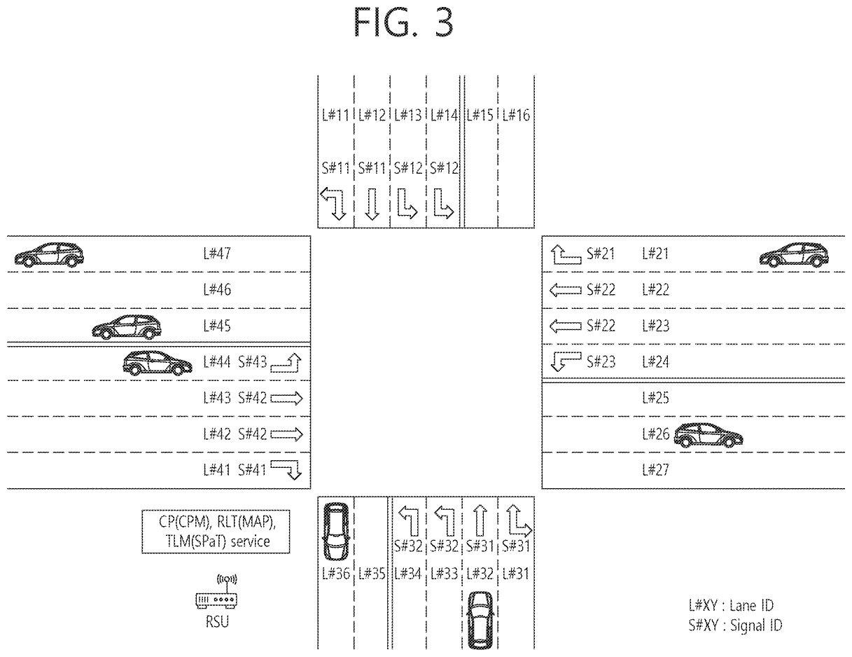

FIG. 3 shows a scenario where an RSU provides ITS services at an intersection. Referring to FIG. 3, the RSU may transmit general information that can be transmitted to vehicles within a communicable distance (in the case of short-range communication) or to vehicles within a designated area (e.g., a tile in the case of Message Queuing Telemetry Transport (MQTT) structure) by transmitting the messages (e.g., MAP, RGA, SPAT or TSPaT, etc.).

Meanwhile, as prior arts of the present disclosure, standards and messages that are currently completed or in progress are as follows. The contents of the standardization of Traffic Light Maneuver (TLM), Road and Lane Topology (RLT), Infrastructure to Vehicle Information (IVI), Traffic Light Control (TLC), GNSS Positioning Correction (GPC), and Decentralized Environment Notification (DEN) services defined in the European communication standard are as follows (ETSI TS 103 301).

According to the ETSI ITS standard (ETSI TS 103 301), the services provided by transport infrastructure and the corresponding messages may be defined as follows.

Infrastructure services mean the facilities layer entities that manage the generation, transmission and reception of infrastructure-related messages from the infrastructure (C-ITS-S (Cooperative ITS-Station) or R-ITS-S(Roadside ITS Station)) to the V-ITS-S (Vehicular and personal ITS Station) or vice versa.

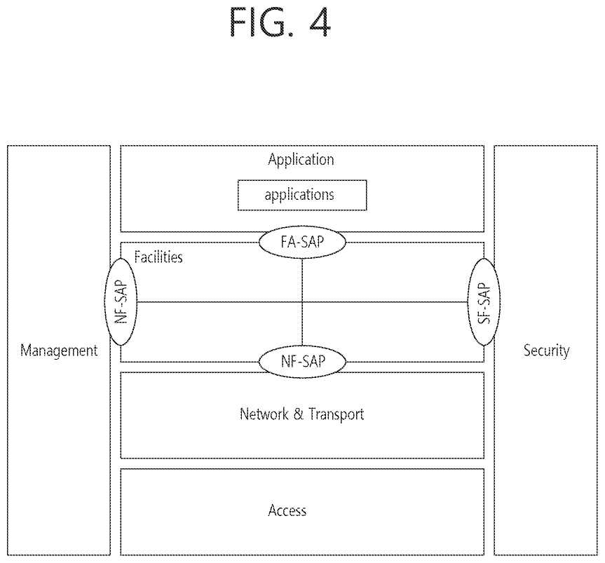

FIG. 4 shows an infrastructure services within an ITS station (ITS-S) structure. Referring to FIG. 4, it shows the high level functional architecture of infrastructure services within the ITS communication architecture as specified in ETSI EN 302 665. The messages are facilities layer Protocol Data Units (PDUs) exchanged between ITS-Ss. The payload is generated by ITS applications on the transmission ITS-S or another connected ITS-S (e.g., C-ITS-S). In ITS-S transmission, message transmission is triggered by the application or forwarding mechanisms. For this purpose, the application may connect to another entity or an external entity in the facilities layer to gather relevant information for payload generation. Once a message is generated, the service may repeat the transmission until the application requests end of transmission, or may trigger another request to generate an updated message. In reception ITS-S, the message is processed by the service and the message content is transmitted on to an application or other facilities layer entity. In one typical application, the message is transmitted by the R-ITS-S and propagated to the V-ITS-S within the target destination area, where the information included in the message is considered relevant to the traffic participants.

Within the scope of the ETSI ITS standard (ETSI TS 103 301), infrastructure services support the management of the message types listed in Table 2 below. As a result, infrastructure services include a set of service entities listed in Table 2 below.

TABLE 2
SPATEM as defined in Annex A. The corresponding service entity is referred as “Traffic Light Maneuver” -
TLM service in the present document. TLM service is specified in clause 5 of the present document.
MAPEM as defined in Annex B. The corresponding service entity is referred as “Road and Lane Topology” -
RLT service in the present document. RLT service is specified in clause 6 of the present document.
IVIM as defined in Annex C. The corresponding service entity is referred as “Infrastructure to Vehicle
Information” - IVI service in the present document. IVI service is specified in clause 7 of the present
document.
SREM as specified in Annex D. The corresponding service entity is referred as “Traffic Light Control” -
TLC service in the present document. TLC service is specified in clause 8 of the present document.
SSEM as specified in Annex E. The corresponding service is referred as “Traffic Light Control” - TLC
service in the present document. TLC service is specified in clause 8 of the present document.
NOTE:
Other message may be supported by infrastructure service in the future.

Infrastructure services shall provide at least the following functionality:

In case of transmission services:
message encoding
transport management

In case of reception services:
message decoding
reception management

The TLM service is described in the ETSI ITS standard (ETSI TS 103 301) as follows:

The TLM service is an instantiation of infrastructure services that manage the generation, transmission, and reception of SPATEM (Signal Phase And Timing Extended Message) messages. TLM services include safety-related information to support traffic participants (e.g., vehicles, pedestrians, etc.) to perform safe operations at intersections. The goal is to enter and exit the intersection “conflict area” in a controlled manner. The TLM service informs the operating state of the traffic light controller, current signal state, remaining time until the next state, and permitted maneuvering time, etc. in real-time and supports crossing. Additionally, the TLM service are expected to include detailed green way advisory information and public transport prioritization state.

The TLM service instantiated in the ITS Station should provide the communication services described above.

The TLM service uses the SPATEM message as defined in the ETSI ITS standard. The header of the SPATEM is as specified in the data dictionary ETSI TS 102 894-2. The data elements of the SPATEM payload are as specified in CEN ISO/TS 19091. The protocolVersion (version of the ITS payload included in the message as defined for a particular infrastructure service) (defined in the header) of the SPATEM message is configured as “2” based on the ETSI ITS standard (ETSI TS 103 301).

Meanwhile, the message transmission period of the TLM service is as follows.

The TLM service provides real-time information about the signal phases and timing of a traffic light at an intersection or part of an intersection, identified by an intersection reference identifier. The timestamp indicates the order of the message within a given time system as defined in CEN ISO/TS 19091. No additional identifiers are required to distinguish a SPATEM from a previous SPATEM.

The application triggers the TLM service to transmit SPATEM. This application provides all data content included in the SPATEM payload. The TLM service configures the SPATEM and transmit it to the ITS Networking & Transport Layer for dissemination. The SPATEM is not repeated. The TLM service is ended when the ITS-S application requests the end.

The TLM service disseminates the state of the traffic signal controller, traffic lights, and intersection traffic information using SPATEM. It continuously transmits information related to all movements within the intersection area in real-time. The goal is to target all traffic participants using the intersection to move or cross the street. Due to the variety of end user's equipment, SPATEM may be disseminated using different access technologies for short-range or long-range communication,

Table 3 below provides the requirements for broadcast communications. Table 3 below shows the TLM service communication requirements for short-range access technologies. The structure of the requirements follows ISO/TS 17423. The ITS station management uses the communication requirements to select the appropriate ITS-S communication protocol stacks. Some examples of communication profile configurations that meet these requirements are specified in the ETSI ITS standard (ETSI TS 103 301).

TABLE 3

| | | |
|---|---|---|
| Requirement | Value | Comment |

Operational parameters

| | | |
|---|---|---|
| CSP_LogicalChannelType | SFCH | |
| CSP_SessionCont | n.a. | No continuous connectivity |
| CSP_AvgADUrate | 255, 1 second (default) | |
| CSP_FlowType | n.a. | |
| CSP_MaxPrio | 254 | |
| CSP_PortNo | 2004 | Port Number of the transport protocol |
| | | (see ETSI TS 103 248 [15]) |
| CSP_ExpFlowLifetime | n.a. | |

Destination related parameters

| | |
|---|---|
| CSP_DestinationType | geo-location-based |
| | GeoBroadcast |
| CSP_DestinationDomain | site-local |
| CSP_ CommDistance | 400 m radius (default value) |
| CSP_Directivity | n.a. |

Performance communication service parameters

| | | |
|---|---|---|
| CSP_Resilience | High | Repeated transmission of the same message |
| CSP_MinThP | n.a. | |
| CSP_MaxLat | Ms 100 (8) | Response within less than 100 ms |
| CSP_MaxADU | Max message size allowed by | |
| | access technology | |

Security related parameters

| | |
|---|---|
| CSP_DataConfidentiality | n.a. |
| CSP_DataIntegrity | required |
| CSP_NonRepudiation | required |
| CSP_SourceAuthentication | required |

Protocol related parameter

| | |
|---|---|
| Protocol-Req | n.a. |

The ETSI ITS standard (ETSI TS 103 301) provides requirements for long-range unicast communications (e.g., using cellular networks) according to ISO/TS 17423. Table 4 below shows the TLM service communication requirements for long-range access technologies.

TABLE 4

| | | |
|---|---|---|
| Requirement | Value | Comment |

Operational communication service parameters

| | | |
|---|---|---|
| CSP_LogicalChannelType | SFCH | |
| CSP_SessionCont | n.a. | No continuous connectivity |
| CSP_AvgADUrate | n.a. | |
| CSP_FlowType | n.a. | |
| CSP_MaxPrio | n.a. | |
| CSP_PortNo | 2004 | Port Number of the transport protocol |
| | | (see ETSI TS 103 248 [15]) |
| CSP_ExpFlowLifetime | n.a. | |

Destination communication service parameters

| | |
|---|---|
| CSP_DestinationType | unicast |
| CSP_DestinationDomain | global |
| CSP_ CommDistance | n.a. |
| CSP_Directivity | n.a. |

Performance communication service parameters

| | |
|---|---|
| CSP_Resilience | required |
| CSP_MinThP | n.a. |
| CSP_MaxLat | n.a. |
| CSP_MaxADU | Max message size allowed by |
| | access technology |

Security communication service parameters

| | |
|---|---|
| CSP_DataConfidentiality | n.a. |
| CSP_DataIntegrity | required |
| CSP_NonRepudiation | required |
| CSP_SourceAuthentication | required |

Protocol related parameter

| | |
|---|---|
| Protocol-Req | n.a. |

Meanwhile, the contents related to RLT service are as follows.

The RLT service is one of the instantiations of infrastructure services to manage the generation, transmission, and reception of digital topology maps that define the topology of an infrastructure area. This includes lane topology, such as vehicles, bicycles, parking, public transport, crosswalk paths, and allowed maneuvers within an intersection area or road segment. Future enhancements will include additional topology descriptions, such as traffic roundabouts, in the digital map. The intersection area described by the topology includes approximately 200m of access road from the stop line location. If the distance between adjacent intersections is less than 400m, approximately half the distance between intersections may be described.

The Road and Lane Topology service instantiated at an ITS Station should provide the transmission or reception services defined in the communication services described above. In addition, the Road and Lane Topology service supports the following functions.
Infinite continuous transmission of MAPEM (MAP (topology) Extended Message). Since MAPEM messages do not change frequently over time, stable releases are stored within the ITS-S for continuous broadcast.
Data element {MAPEM.map.layerID} as defined in ISO/TS 19091, assembles and disassembles fragmented MAPEM fragments at the application level.

The RLT service uses the MAPEM message as defined in the ETSI ITS standard (ETSI TS 103 301). The MAPEM header is as specified in the data dictionary ETSI TS 102 894-2. The data elements of the MAPEM payload are defined in CEN ISO/TS 19091. The protocolVersion (version of the ITS payload included in the message as defined for a specific infrastructure service) (defined in the header) of the MAPEM message based on the ETSI ITS standard (ETSI TS 103 301) is set to “2”.

The RLT service uses MAPEM that shows the topology/geometry of a set of lanes. For example, considering an intersection, the MAPEM defines the topology of the lane or part of the topology of the lane, identified by the intersection reference identifier. MAPEM do not change frequently over time. Unless the application indicates a new MAPEM to be transmitted, the same MAPEM is retransmitted with the same content. If the size of the MAPEM exceeds the allowed message length (e.g., the Maximum Transmit Unit (MTU)), the RLT service fragments the message and transmits it in different messages. Each fragment is identified by a “layerID” as defined in ISO/TS 19091.

The application triggers the road and lane topology service for MAPEM transmission. The application provides all data content included in the MAPEM payload. The RLT service configures the MAPEM and transmit it to the ITS Networking & Transport Layer for dissemination. Since only the MAPEM content changes (e.g., when the road and lane topology changes), the MAPEM remains stable in time. The MAPEM is continuously re-broadcasted. The MAPEM transmission may be ended when the ITS-S application requests the end of the transmission.

The RLT service uses MAPEM to define all road terrain details. It uses a lane “connection” (between incoming and outgoing lanes) that includes a signal group identifier which is a link for SPATEM signal information. MAPEM should be transmitted continuously along with SPATEM to inform traffic participants (drivers, pedestrians, etc.) of the permitted manoeuvring conditions within the intersection conflict zone. Since the communication path to the end user may be different, MAPEM may be disseminated using different access technologies for short-range and long-range communications.

Table 5 below provides the requirements for broadcast communications. Table 5 below shows the RLT service communication requirements for short-range access technologies. The structure of the requirements follows ISO/TS 17423. The ITS station management uses the communication requirements to select the appropriate ITS-S communication protocol stack. Some examples of communication parameter configurations that meet these requirements are specified in the ETSI ITS standard (ETSI TS 103 301).

TABLE 5

| | | |
|---|---|---|
| Requirement | Value | Comment |

Operational parameters

| | | |
|---|---|---|
| CSP_LogicalChannelType | SFCH | |
| CSP_SessionCont | n.a. | No continuous connectivity |
| CSP_AvgADUrate | 255, 1 second (default) | |
| CSP_FlowType | n.a. | |
| CSP_MaxPrio | 253 | |
| CSP_PortNo | 2003 | Port Number of the transport protocol |
| | | (see ETSI TS 103 248 [15]) |
| CSP_ExpFlowLifetime | n.a. | |

Destination communication service parameters

| | |
|---|---|
| CSP_DestinationType | geo-location-based |
| | GeoBroadcast |
| CSP_DestinationDomain | site-local |
| CSP_ CommDistance | 400 m radius (default value) |
| CSP_Directivity | n.a. |

Performance communication service parameters

| | | |
|---|---|---|
| CSP_Resilience | High | Repeated transmission of the same message |
| CSP_MinThP | n.a. | |
| CSP_MaxLat | ms 100 (8) | Response with less than 100 ms |
| CSP_MaxADU | Max message size allowed by | |
| | access technology | |

Security communication service parameters

| | |
|---|---|
| CSP_DataConfidentiality | n.a. |
| CSP_DataIntegrity | required |
| CSP_NonRepudiation | required |
| CSP_SourceAuthentication | required |

Protocol related parameter

| | |
|---|---|
| Protocol-Req | n.a. |

The ETSI ITS standard (ETSI TS 103 301) provides requirements for long-range unicast communications (e.g., using cellular networks) according to ISO/TS 17423. Table 6 below presents the RLT service communication requirements for long-range access technologies.

TABLE 6

| | | |
|---|---|---|
| Requirement | Value | Comment |

Operational communication service parameters

| | | |
|---|---|---|
| CSP_LogicalChannelType | SFCH | Safety channel |
| CSP_SessionCont | n.a. | |
| CSP_AvgADUrate | n.a. | |
| CSP_FlowType | n.a. | |
| CSP_MaxPrio | n.a. | |
| CSP_PortNo | 2003 | Port Number of the transport protocol |
| | | (see ETSI TS 103 248 [15]) |
| CSP_ExpFlowLifetime | n.a. | |

Destination communication service parameters

| | |
|---|---|
| CSP_DestinationType | unicast |
| CSP_DestinationDomain | global |
| CSP_ CommDistance | n.a. |
| CSP_Directivity | n.a. |

Performance communication service parameters

| | |
|---|---|
| CSP_Resilience | required |
| CSP_MinThP | n.a. |
| CSP_MaxLat | n.a. |
| CSP_MaxADU | Max message size allowed by |
| | access technology |

Security communication service parameters

| | |
|---|---|
| CSP_DataConfidentiality | n.a. |
| CSP_DataIntegrity | required |
| CSP_NonRepudiation | required |
| CSP_SourceAuthentication | required |

Protocol related parameter

| | |
|---|---|
| Protocol-Req | n.a. |

Meanwhile, in addition to the TLM (e.g., SPaT) and RLT (e.g., MAP) described above, the method proposed in the present disclosure may correspond to the following standards as examples of ITS services.
ETSI TS 103 301: IVI (Infrastructure to Vehicle Information), TLC (Traffic Light Control), GPC (GNSS Positioning Correction)
ETSI EN 302 637-3: DEN (Decentralized Environmental Notification)
SAE J2735: RSA (Road Side Alert)
SAE J2945-3: RWM (Road Weather Message)
SAE J2945-4: RSM (Road Safety Message)
SAE J2945-A: RGA (Road Geometry Attributes)

Meanwhile, the SAE standards (SAE J2945-A RGA) currently undergoing standardization are as shown in Table 7 below.

TABLE 7

| | |
|---|---|
| Use Case Name | Large Road Geometry |
| Category | Safety, Mobility |
| Infrastructure Role | Delivery of the mapped geometry DS partitions |
| | Transmission of the RTCM corrections DS |
| Short Description | The geometry for a complex intersection is being provided in a mapped geometry DS. The |
| | message containing the DS is being transmitted locally. Given the constraints of the |
| | transmission medium, the mapped road geometry and associated attributes are too large to |
| | fit into a single mapped geometry message. To stay within size constraints, the mapped |
| | geometry DS is split into multiple partitions, each sent separately. |
| | Given the lane a CV is driving in, it may only need one of the mapped geometry partitions, |
| | however, to transverse the full mapped area, all partitions are required. |
| Goal | To enable large geometry mapped areas to be defined as a single set by enabling a |
| | partitioning of the data which can be reassembled upon reception of all the partitions. |
| Constraints | Mapped geometry and RTCM corrections DSs are available at the location the CV is |
| | driving |
| | The CV supports and can receive the mapped geometry and RTCM corrections DSs via |
| | the supported interface(s) |
| | Security solution in place to enable secure data exchange and authentication of data |
| | sources |
| Geographic Scope | Localized to the geographic area represented by the mapped geometry DS |
| Actors | Infrastructure-based communications system |
| | CV |
| Preconditions | Operational scenario 1: mapped geometry availability and |
| | Operational scenario 2: mapped geometry lane selection using position |
| Main Flow | 1. The red CV in the ‘Illustration’ receives all the mapped geometry partitions as separate |
| | messages (Mapped Geometry DS Partition 1 and Mapped Geometry DS Partition 2 per the |
| | illustration for this scenario) |
| | 2. Per Operational scenario 1: mapped geometry availability and, it determines the mapped |
| | area is pertinent to its current position, so it decodes the DS partitions fully |
| | 3. From information in the DS, the CV is aware that the two messages together comprise a |
| | single mapped area DS, so it combines the data into a single DS |
| | 4. Then, via the RP information and node offset information and per Operational scenario |
| | 2: mapped geometry lane selection using position, the CV determines which lane applies |
| | to its current lane |
| | 5. The CV processes the attributes contained in the combined mapped geometry DS and |
| | potentially other DSs (e.g., traffic signal information) depending on its application set |
| Alternate flow(s) | Alternate Flow 1 |
| | 1. The CV only receives one of the mapped geometry partitions |
| | 2. It performs steps 1-5 of the ‘Main Flow’ pertaining to the partition it has received |
| | Alternate Flow 2 |
| | 1. The mapped geometry DS partitions are determined to not be relevant to the current CV |
| | lane |
| | 2. No further operations are performed by the CV regarding the mapped geometry DS |
| | partitions |
| Post-conditions | The red CV in the ‘Illustration’ continues to process the mapped geometry DS partitions |
| | until it departs the mapped area. |
| Information | All the mapped geometry partition messages, each which includes the RP data |
| Requirements | corresponding to the mapped geometry |
| | RTCM corrections DS corresponding to the mapped geometry DS |
| | CV position |
| Source Documents / | N/A |
| References | |

Meanwhile, the current ITS (Intelligent Transportation System) service basically does not consider the state of the receiver (e.g., location, speed, direction, etc.), and may provide services to all receivers located within a distance where peripheral communication is possible (in the case of short-range communication) or located in a designated area (in the case of long-range communication). In this case, for example, the services are transmitted to an unspecified number of receivers located in the relevant area, and general information including somewhat unnecessary information may be shared with some receivers, which may increase network traffic. In addition, for example, for receivers with lack of computing capacity, processing a lot of information may be burdensome, which can make it difficult to use all the services provided by the transportation infrastructure. In addition, for example, for time-dependent information (e.g., signal information, sensor information, etc.), the information may not be available due to communication delay.

In the present disclosure, a method of providing information aperiodically to specific road users or groups of road users (with whom communication is possible) or transmitting only valid information (e.g., removing unnecessary information to the receiver and only transmitting necessary information) when an ITS service provider (e.g., Road Side Unit (RSU) or ITS server) provides ITS services (e.g., Traffic Light Maneuver (TLM), Road and Lane Topology (RLT), Infrastructure to Vehicle Information (IVI) services, etc.) in unicast or groupcast, and a device supporting the same are proposed.

In the present disclosure, a method and a device supporting the same are proposed, in which a service provider adjusts the number of transmissions/periods of ITS service messages and edits information according to the state of a receiver (or a group of receivers) to provide only the information required by the receiver.

For example, a service provider may check the state of a receiver (e.g., a road user) (or a group of receivers (e.g., a group of road users)) to determine the information required by the receiver. For example, the receiver may directly or indirectly transmit its state through various types of messages, or request necessary information from the service provider. For example, when a road user transmits a Cooperative Awareness Message (CAM) or Basic Safety Message (BSM) of V2X communication, the service provider may indirectly obtain the information required by the road user by identifying the current state of the road user and inferring the necessary information. For example, when a road user directly transmits its information and a request message requesting information it needs to the service provider, the service provider may directly obtain the information required by the road user.

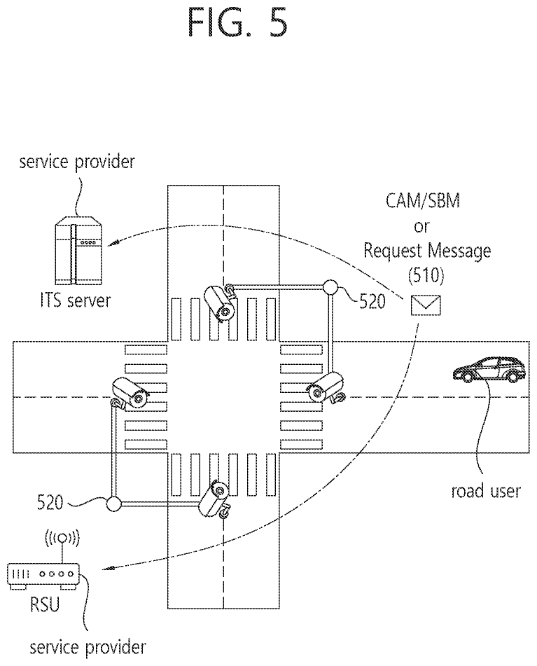

FIG. 5 shows a method for a service provider to directly/indirectly identify necessary information of a road user. For example, in addition to the method illustrated in FIG. 5, a road user may transmit driving information such as its type, location, speed, direction, or expected path to a service provider 510, or a service provider may directly measure (e.g., measure using LiDAR or a camera) 520 and determine the driving information of a road user.

For example, there may be various ways for service providers to efficiently provide ITS services by reflecting various factors including the characteristics of road users. For example, service providers (e.g., RSUs or ITS servers) may provide services efficiently by changing the timing or frequency of information transmission and changing periodic transmission to aperiodic transmission based on the validity of the information provided to road users. In addition, for example, the service provider may efficiently provide a service by classifying the information to be provided by zone, dynamic/static information, and information characteristics based on the current state or predicted information of the receiver (or receiver group), processing it into information corresponding to the receiver (or receiver group), and transmitting a message to the receiver. That is, for example, a service provider may select valid information from the current state of the receiver (e.g., location, direction, speed, etc.). And, for example, valid information may be selected from information that service provider senses or predicts the driving intention (e.g., turn signal) of the receiver, or information that receiver directly transmit its driving intention or planned path to the service provider.

In the present disclosure, in the manner described above, it is proposed that the service provider provide information transmission in various ways according to the current state information of the receiver or the request message, and process and provide only valid information.

In another embodiment, there is a method in which the service provider provides a service using a publish/subscribe model structure.

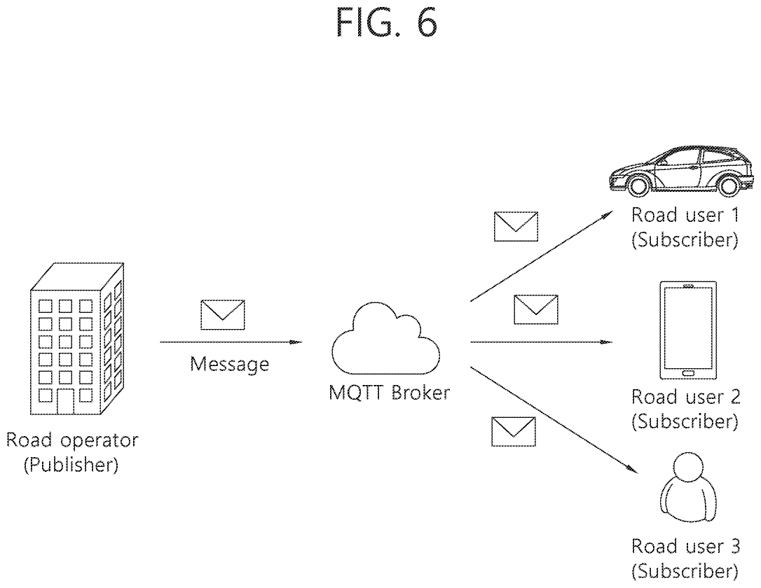

FIG. 6 shows a method for a service provider to provide a service using a publish/subscribe model structure. That is, for example, as in FIG. 6, a service provider (publisher) publishes an ITS service to a server (MQTT broker), and a road user (subscriber) may use the service by subscribing to only valid information. In this case, for example, a road user may receive only valid information by actively repeatedly subscribing to and canceling a service from the server.

In an embodiment of the present disclosure, a service provider (e.g., an RSU or a server) may provide map information (MAP) and signal information (SPaT) to a road user (e.g., a vehicle or a receiver).

For example, in the case of providing map information, the RSU may provide the map information of the static Road and Lane Topology (RLT) service to the receiver only once. For example, when a service provider provides a service by broadcast, it transmits periodically, so even if the receiver already has the information or the direction of movement changes and does not need the map information, the receiver may occupy bandwidth to receive the same information. However, for example, when a service provider provides a service by unicast or groupcast, if the receiver has properly received the map information related to the driving path only once, it may not receive it anymore. That is, for example, when the RSU (or server) provides a service to the receiver through unicast or groupcast, it may check whether the receiver has valid map information of the area corresponding to the location and direction of the receiver, and if not, it may transmit it only once and end the RLT service. Alternatively, for example, the receiver may transmit a request message including its information and/or required information to the service provider, and the service provider may provide the required information to the receiver in response. In this case, for example, the request message may be a simplified form of a state message (e.g., CAM or BSM).

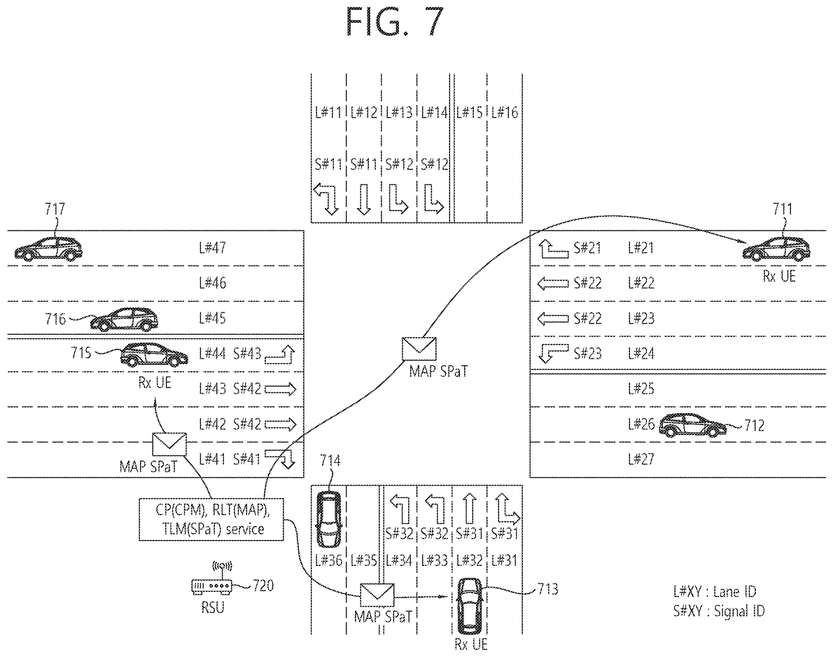

FIG. 7 shows an operation of a road side unit (RSU) providing road and lane topology (RLT) and traffic light maneuver (TLM) services at an intersection, based on an embodiment of the present disclosure. The embodiment of FIG. 7 may be combined with various embodiments of the present disclosure.

Referring to FIG. 7, RSU 720 may provide map information of the intersection to three vehicles 711, 713, 715 that require map information (i.e., vehicles approaching the intersection), based on information (e.g., location and direction) of seven vehicles 711 to 717 around the intersection. For example, the service provider 720 may transmit map information only to three related vehicles 711, 713, 715 among the seven vehicles 711 to 717 at the intersection. Alternatively, for example, in the case of a request/response-based service, the service provider may provide map information only to the vehicle that requested it.

Additionally, for example, if the RSU knows the driving path and planned path of the receiver in advance in various ways, it may be effective to provide a summary of the map information.

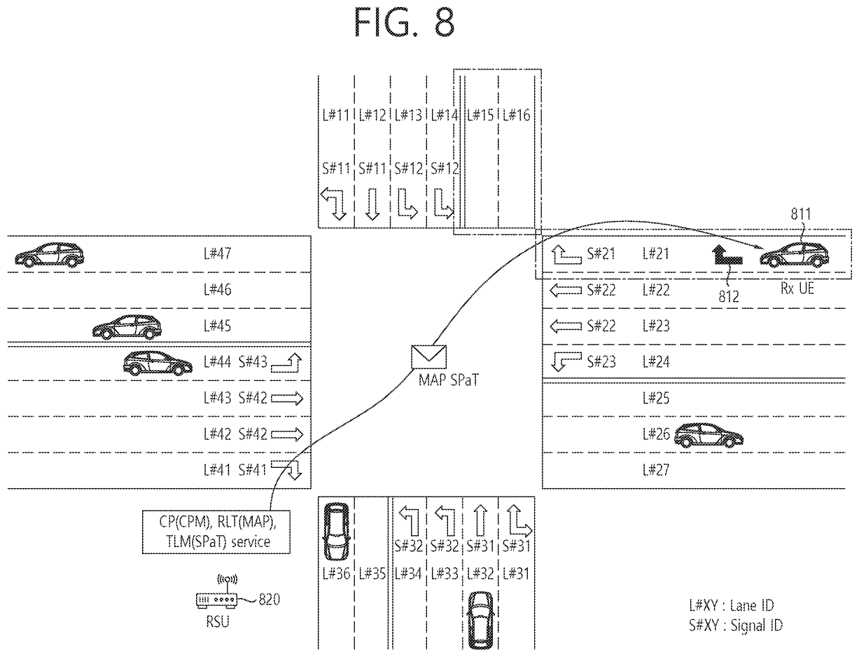

FIG. 8 shows an operation of providing map information to a receiver when an RSU knows the driving path of the receiver, based on an embodiment of the present disclosure. The embodiment of FIG. 8 may be combined with various embodiments of the present disclosure.

Referring to FIG. 8, if the receiver 811 is planning a right turn 812 and driving, the RSU 820 that provides map information to the receiver does not need all of the map information L #11 to L #47 and only needs the relevant map information L #21, L #15, L #16, so the RSU may summarize and transmit only the necessary information. Additionally, for example, if the map information is divided into several parts, the service provider may provide the receiver with a part or a combination of parts corresponding to the required area. At this time, for example, the method by which the service provider divides the map information into several parts may be diverse, such as analyzing geographical characteristics, (statistical, current) traffic flow, etc., and/or using artificial intelligence, etc. For example, if the receiver makes a direct request to the service provider, the receiver may request and receive only the necessary parts from the map information divided into several parts.

For example, signal information (SPaT) is time-dependent information, unlike map information, so the service provider may provide information periodically or aperiodically according to changes in the information. However, for example, in the case of broadcast, referring to the embodiment of FIG. 8 above, the transmitter may transmit all signal information S #11 to S #43 to the receiver periodically (e.g., 1 Hz) regardless of the location and direction of the receiver. In this case, for example, the bandwidth of the communication may be inefficiently used, and processing resources and battery consumption of the receiver may be accelerated. Meanwhile, in the present disclosure, a method of aperiodically transmitting signal information through unicast or groupcast is proposed. For example, the next transmission and reception time may be determined by time information (e.g., minEndTime) until the signal is changed in the signal information. For example, in the FIG. 8 above, if the minEndTime (the time the current signal is maintained) of S #21 is 30.0 seconds, the information of the corresponding signal ID S #21 may not need to be retransmitted or re-received for 30 seconds. That is, for example, while the signal is not changed, the operation of the transmitter transmitting signal information to the receiver is reduced, so that the resources of the transmitter and the receiver may be saved. For example, in the FIG. 8 above, if the RSU (e.g., transmitter) does not have driving path information of the receiver, i.e., does not know in which direction the vehicle 811 will move and needs to receive all signal information S #21 to S #23, the offset time until the next transmission may be determined by the value min {minEndTime (S #21), (S #22), (S #23)}.

For example, the service provider may solve the above problems by transmitting only the relevant signal information based on the location and direction of the receiver, and the receiver may receive it. For example, in the FIG. 8 above, the RSU 820 may transmit only the selected signal information S #21 to S #23 based on the location and direction of the receiver 811 (i.e., S #11, S #12, S #31, S #32, S #33, S #41, S #42, S #43 are unnecessary signals). In addition, for example, if the RSU 820 knows the driving path (812 of FIG. 8) of the receiver 811, the signal information (S #21 of FIG. 8) may be further summarized.

For example, when a road user uses a service by requesting the service provider with a request message requesting the road user's own information and required information, rather than an awareness message (e.g., CAM or BSM), the road user may request the service provider by including the information described above in the request message (e.g., transmission time of required information or Signal ID, etc.).

Meanwhile, in the present disclosure, a method is proposed in which a service provider provides a service with a publish/subscribe model structure. For example, as described above, signal information is information that depends on map information, so it can be interpreted and used only when valid map information is available. Therefore, for example, in order to receive map information preferentially, it may subscribe to the map information and receive it, and then cancel the subscription after confirming whether the map information is valid. And, for example, it may subscribe to and receive signal information after that. For example, as described above, since the signal information does not change during the time of the value of minEndTime, it may save the receiver's resources (e.g., processing or battery, etc.) by unsubscribing during that time. In this case, for example, the offset time for the next resubscription (or UnsubTime) may be calculated as min {minEndTime (S #21), (S #22), (S #23)}, and the changed signal information may be received by resubscribing after that time.

Meanwhile, it may be applied to other ITS services other than the embodiments described above. For example, there may be Infrastructure to Vehicle Information (IVI) service, Decentralized Environmental Notification Basic Service (DEN) or Road Side Alert (RSA).

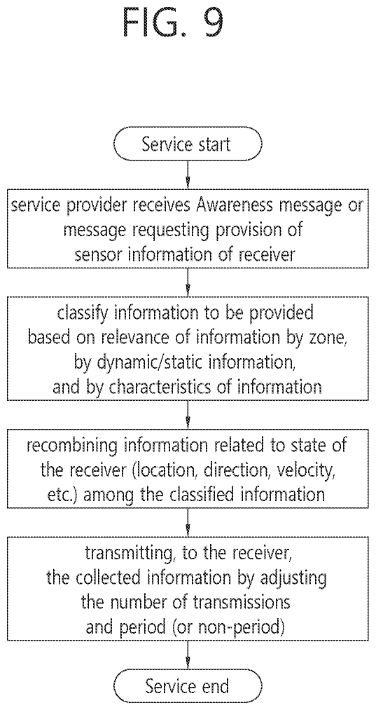

FIG. 9 shows a flowchart of an operation for providing map information and signal information using unicast or groupcast, based on an embodiment of the present disclosure. The embodiment of FIG. 9 may be combined with various embodiments of the present disclosure.

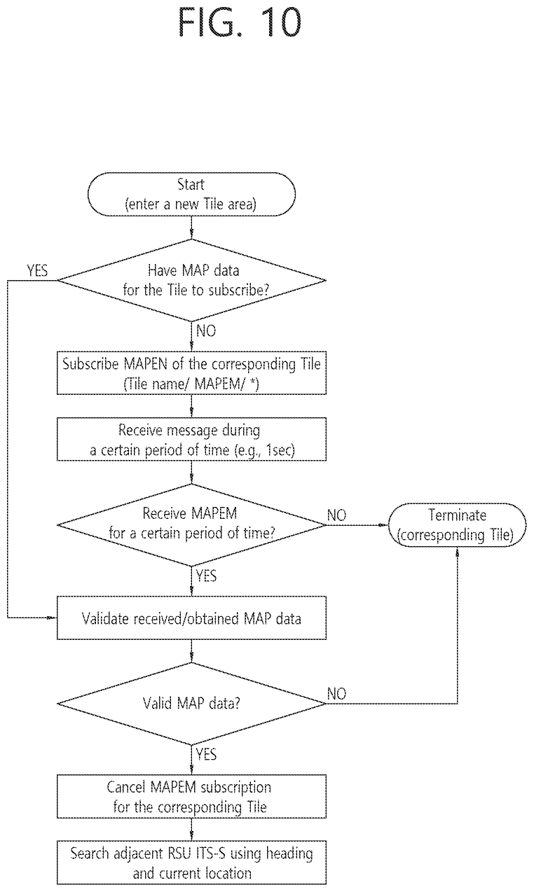

FIG. 10 shows a flowchart of an operation for providing a service related to a MAPEM message with a publish/subscribe model structure, based on an embodiment of the present disclosure. The embodiment of FIG. 10 may be combined with various embodiments of the present disclosure.

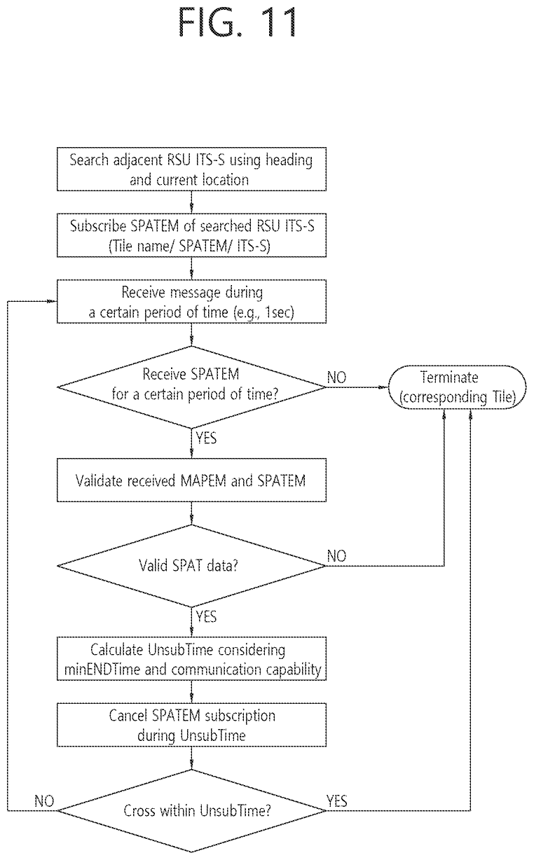

FIG. 11 shows a flowchart of an operation for providing a service related to a SPATEM message with a publish/subscribe model structure, based on an embodiment of the present disclosure. The embodiment of FIG. 11 may be combined with various embodiments of the present disclosure.

Meanwhile, the contents proposed in the present disclosure may be applied to Table 7 above and modified as in Table 8 below.

TABLE 8

| | |
|---|---|
| Use Case Name | Large Road Geometry |
| Category | Safety, Mobility |
| Infrastructure Role | Delivery of the specified/mapped geometry DS partitions related to receiving Vehicle |
| | Transmission of the RTCM corrections DS |
| Short Description | The geometry for a complex intersection is being provided in a mapped geometry DS. The |
| | message containing the DS is being transmitted. Given the constraints of the transmission |
| | medium, the mapped road geometry and associated attributes are too large to fit into a single |
| | mapped geometry message. To stay within size constraints, the mapped geometry DS is |
| | split into multiple partitions, each sent separately or specified partitions relevant to the |
| | receiving vehicle sent using unicast or groupcast. For example, infrastructure predicts path |
| | of a receiving vehicle based on BSM or a request message and sorts out the relevant road |
| | geometry and associated attributes to predicted path of the vehicle. Then the infrastructure |
| | transmits the simplified relevant geometry DS with small data size to the vehicle using |
| | unicast or groupcast. |
| | The partitioning method can be determined by the infrastructure or vehicle request. |

Meanwhile, based on the contents proposed in the present disclosure, the contents of the ETSI ITS standard (ETSI TS 103 301) described above may be applied by modifying/adding as follows.

The TLM service provides real-time information about the signal phases and timing of a traffic light at an intersection or part of an intersection, identified by an intersection reference identifier. The timestamp indicates the order of the message within a given time system as defined in CEN ISO/TS 19091. No additional identifiers are required to distinguish a SPATEM from a previous SPATEM.

The application triggers the TLM service for SPATEM transmission. This application provides all data content included in the SPATEM payload. If the SPATEM may be transmitted using unicast or groupcast, the relevant data content (signal phase and timing) for the receiving V-ITS-S is transmitted to the V-ITS-S according to the location, direction, and speed of the V-ITS-S. The TLM service configures the SPATEM and transmits it to the ITS Networking & Transport Layer for dissemination. The SPATEM is not repeated. The TLM service is ended if the ITS-S application requests the end.

The TLM service disseminates the state of the traffic signal controller, traffic lights, and intersection traffic information using SPATEM. It continuously transmits information related to all operations within the intersection area in real time. When transmitting SPATEM using unicast and groupcast, it transmits information related to the receiving V-ITS-S non-continuously based on the predicted path of the V-ITS-S. The goal is to target all traffic participants using the intersection for movement or crossing. Due to the diverse equipment of end users, SPATEM may be propagated using different access technologies for short-range or long-range communications.

Table 3 above provides requirements for broadcast communication. Table 3 above shows the TLM service communication requirements for short-range access technologies. The structure of the requirements follows ISO/TS 17423. The requirements are different when information is provided using unicast or groupcast.

ITS station management uses communication requirements to select the appropriate ITS-S communication protocol stacks. Some examples of communication profile configurations that meet these requirements may be specified in the ETSI ITS standard (ETSI TS 103 301).

The RLT service uses MAPEMs to represent the topology/geometry of a set of lanes. For example, considering an intersection, MAPEM defines a lane topology or a part of a lane topology, identified by an intersection reference identifier. MAPEM does not change frequently over time. Unless the application indicates that a new MAPEM be transmitted, the same MAPEM is retransmitted with the same content. If the size of the MAPEM exceeds the allowed message length (e.g., the Maximum Transmit Unit (MTU)), the RLT service fragments the message and transmits it as different messages. Each fragment is identified by a “layerID” as defined in ISO/TS 19091. If the MAPEM may be transmitted using unicast or groupcast, the relevant MAP fragment for the receiving V-ITS-S is transmitted to the V-ITS-S according to the location, direction, and velocity of the V-ITS-S.

The application triggers the road and lane topology service for MAPEM transmission. The application provides all data content included in the MAPEM payload. The RLT service configures the MAPEM and transmits it to the ITS Networking & Transport Layer for dissemination. Since only the MAPEM content changes (e.g., when the road and lane topology changes), the MAPEM remains stable in time. The MAPEM is continuously re-broadcasted. If the MAPEM may be transmitted using unicast or groupcast, the MAPEM is re-transmitted until the V-ITS-S is received. The MAPEM transmission may be ended when the ITS-S application requests the end of the transmission.

The RLT service uses MAPEM to define all road terrain details. It uses a lane “connection” (between incoming and outgoing lanes) that includes a signal group identifier which is a link for SPATEM signal information. MAPEM should be transmitted together with SPATEM to inform traffic participants (drivers, pedestrians, etc.) of the permitted manoeuvring conditions within the intersection conflict zone. Since the communication path to the end user may be different, MAPEM may be disseminated using different access technologies for short-range and long-range communications.

Table 5 above provides requirements for broadcast communication. Table 5 above shows the RLT service communication requirements for short-range access technologies. The structure of the requirements follows ISO/TS 17423. The requirements are different when information is provided using unicast or groupcast.

ITS station management uses the communication requirements to select the appropriate ITS-S communication protocol stack. Some examples of communication parameter configurations that meet these requirements are specified in the ETSI ITS standard (ETSI TS 103 301).

According to various embodiments of the present disclosure, due to the improvement of the computing capability of transportation infrastructure (e.g., transmitters) and the development of technologies for long-range communication (e.g., Uu interface) and short-range communication (e.g., NR-V2X), unicast and groupcast have become possible in addition to the existing broadcast, so that the transmitter may selectively provide only the information necessary for the receiver. For example, this function may prevent the service from excessively occupying the communication channel in terms of network traffic, and may reduce the data downlink in the case of long-range communication. Additionally, for example, on the receiver side, processing resources for processing received data may be saved or the service may be used with less processing power. Additionally, for example, in a receiver where battery consumption is important, battery consumption may be reduced.

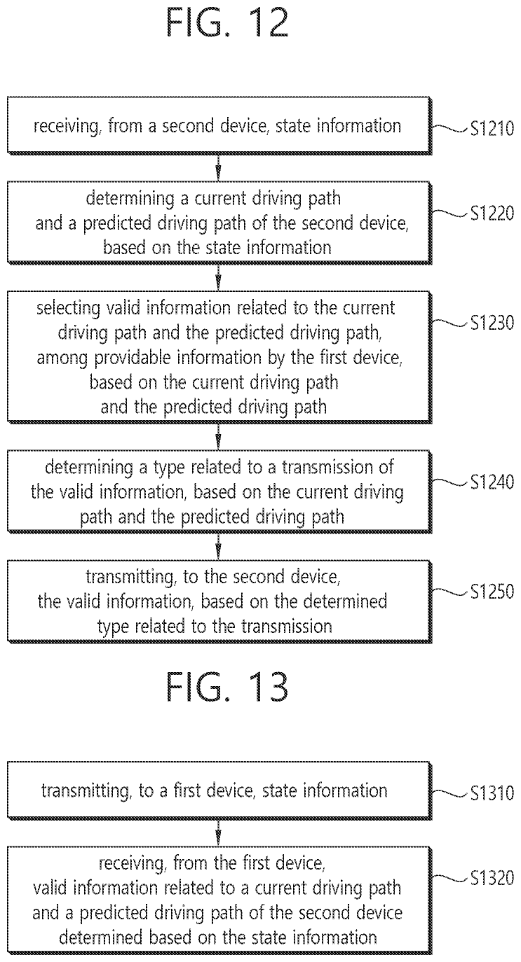

FIG. 12 shows a method for performing wireless communication by a first device, based on an embodiment of the present disclosure. The embodiment of FIG. 12 may be combined with various embodiments of the present disclosure.

Referring to FIG. 12, in step S1210, a first device may receive, from a second device, state information. In step S1220, the first device may determine a current driving path and a predicted driving path of the second device, based on the state information. In step S1230, the first device may select valid information related to the current driving path and the predicted driving path, among providable information by the first device, based on the current driving path and the predicted driving path. In step S1240, the first device may determine a type related to a transmission of the valid information, based on the current driving path and the predicted driving path. In step S1250, the first device may transmit, to the second device, the valid information, based on the determined type related to the transmission.

For example, the type related to the transmission of the valid information may be determined as an aperiodic transmission, based on the valid information being a two-way communication-based information. For example, the two-way communication may be based on at least one of unicast or groupcast.

For example, a type related to a transmission of map information may be determined as an aperiodic transmission, based on the valid information being the map information related to the current driving path and the predicted driving path of the second device. For example, the map information may be information excluding map information which is not related to the current driving path and the predicted driving path of the second device from among the providable information. Additionally, for example, the first device may determine whether the second device has the map information. For example, the type related to the transmission of the map information may be determined as a one-time transmission, based on the determination that the second device does not have the map information.

For example, a type related to a transmission of signal information may be determined as an aperiodic transmission, based on the valid information being the signal information related to the current driving path and the predicted driving path of the second device. For example, the signal information may be information excluding signal information which is not related to the current driving path and the predicted driving path of the second device from among the providable information. For example, the signal information may be information that changes over time, and the type related to the transmission of the signal information may be determined as the aperiodic transmission, based on a change time of the signal information. For example, the aperiodic transmission may be based on one transmission per the change time of the signal information. For example, the aperiodic transmission may be based on the transmission of the signal information being stopped before a change of the signal information after the transmission of the signal information.

For example, the state information may include information related to at least one of a location, a direction, a velocity, or driving intention of the second device.

For example, the state information may be received, from the second device, based on at least one of a cooperative awareness message (CAM) or a basic safety message (BSM).

The proposed method may be applied to devices according to various embodiments of the present disclosure. First, a processor 102 of a first device 100 may control a transceiver 106 to receive, from a second device, state information. And, the processor 102 of the first device 100 may determine a current driving path and a predicted driving path of the second device, based on the state information. And, the processor 102 of the first device 100 may select valid information related to the current driving path and the predicted driving path, among providable information by the first device, based on the current driving path and the predicted driving path. And, the processor 102 of the first device 100 may determine a type related to a transmission of the valid information, based on the current driving path and the predicted driving path. And, the processor 102 of the first device 100 may control the transceiver 106 to transmit, to the second device, the valid information, based on the determined type related to the transmission.

According to one embodiment of the present disclosure, provided is a first device configured to perform wireless communication. The first device may comprise: at least one transceiver; at least one processor; and at least one memory connected to the at least one processor and storing instructions. For example, the instructions, based on being executed by the at least one processor, cause the first device to perform operations comprising: receiving, from a second device, state information; determining a current driving path and a predicted driving path of the second device, based on the state information; selecting valid information related to the current driving path and the predicted driving path, among providable information by the first device, based on the current driving path and the predicted driving path; determining a type related to a transmission of the valid information, based on the current driving path and the predicted driving path; and transmitting, to the second device, the valid information, based on the determined type related to the transmission.

According to one embodiment of the present disclosure, provided is a processing device configured to control a first device. The processing device may comprise: at least one processor; and at least one memory connected to the at least one processor and storing instructions. For example, the instructions, based on being executed by the at least one processor, cause the first device to perform operations comprising: receiving, from a second device, state information; determining a current driving path and a predicted driving path of the second device, based on the state information; selecting valid information related to the current driving path and the predicted driving path, among providable information by the first device, based on the current driving path and the predicted driving path; determining a type related to a transmission of the valid information, based on the current driving path and the predicted driving path; and transmitting, to the second device, the valid information, based on the determined type related to the transmission.

According to one embodiment of the present disclosure, provided is a non-transitory computer-readable storage medium recording instructions. For example, the instructions, based on being executed, cause a first device to perform operations comprising: receiving, from a second device, state information; determining a current driving path and a predicted driving path of the second device, based on the state information; selecting valid information related to the current driving path and the predicted driving path, among providable information by the first device, based on the current driving path and the predicted driving path; determining a type related to a transmission of the valid information, based on the current driving path and the predicted driving path; and transmitting, to the second device, the valid information, based on the determined type related to the transmission.

FIG. 13 shows a method for performing wireless communication by a second device, based on an embodiment of the present disclosure. The embodiment of FIG. 13 may be combined with various embodiments of the present disclosure.

Referring to FIG. 13, in step S1310, a second device may transmit, to a first device, state information. In step S1320, the second device may receive, from the first device, valid information related to a current driving path and a predicted driving path of the second device determined based on the state information. For example, the valid information may be received based on a type of a transmission determined based on the current driving path and the predicted driving path of the second device.

The proposed method may be applied to devices according to various embodiments of the present disclosure. First, a processor 202 of a second device 200 may control a transceiver 206 to transmit, to a first device, state information. And, the processor 202 of the second device 200 may control a transceiver 206 to receive, from the first device, valid information related to a current driving path and a predicted driving path of the second device determined based on the state information. For example, the valid information may be received based on a type of a transmission determined based on the current driving path and the predicted driving path of the second device.

According to one embodiment of the present disclosure, provided is a second device configured to perform wireless communication. The second device may comprise: at least one transceiver; at least one processor; and at least one memory connected to the at least one processor and storing instructions. For example, the instructions, based on being executed by the at least one processor, cause the second device to perform operations comprising: transmitting, to a first device, state information; and receiving, from the first device, valid information related to a current driving path and a predicted driving path of the second device determined based on the state information. For example, the valid information may be received based on a type of a transmission determined based on the current driving path and the predicted driving path of the second device.

According to one embodiment of the present disclosure, provided is a processing device configured to control a second device. The processing device may comprise: at least one processor; and at least one memory connected to the at least one processor and storing instructions. For example, the instructions, based on being executed by the at least one processor, cause the second device to perform operations comprising: transmitting, to a first device, state information; and receiving, from the first device, valid information related to a current driving path and a predicted driving path of the second device determined based on the state information. For example, the valid information may be received based on a type of a transmission determined based on the current driving path and the predicted driving path of the second device.

According to one embodiment of the present disclosure, provided is a non-transitory computer-readable storage medium recording instructions. For example, the instructions, based on being executed, cause a second device to perform operations comprising: transmitting, to a first device, state information; and receiving, from the first device, valid information related to a current driving path and a predicted driving path of the second device determined based on the state information. For example, the valid information may be received based on a type of a transmission determined based on the current driving path and the predicted driving path of the second device.

Various embodiments of the present disclosure may be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

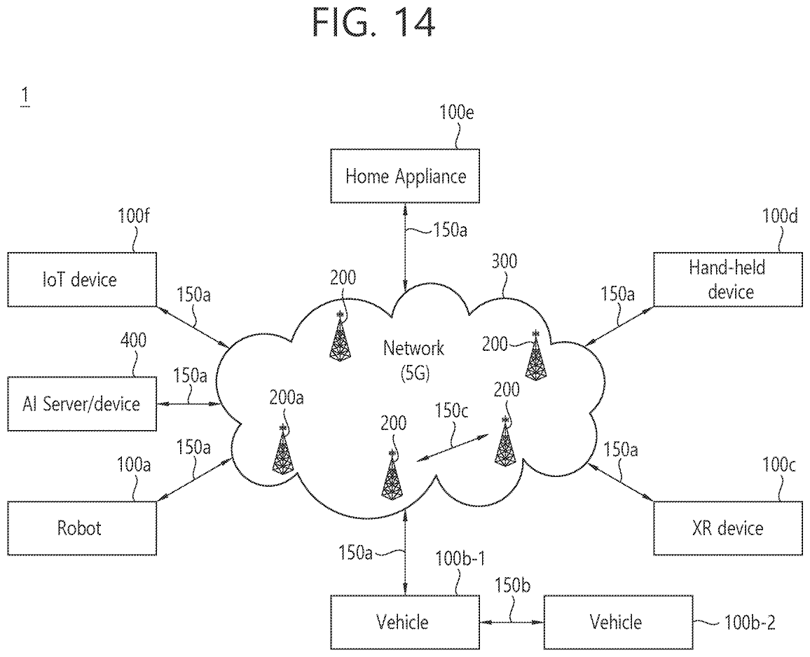

FIG. 14 shows a communication system 1, based on an embodiment of the present disclosure. The embodiment of FIG. 14 may be combined with various embodiments of the present disclosure.

Referring to FIG. 14, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (LAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

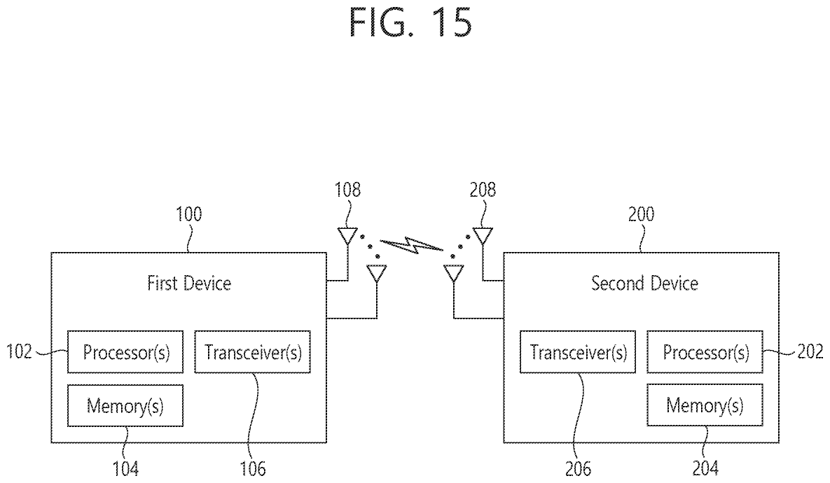

FIG. 15 shows wireless devices, based on an embodiment of the present disclosure. The embodiment of FIG. 15 may be combined with various embodiments of the present disclosure.

Referring to FIG. 15, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 14.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

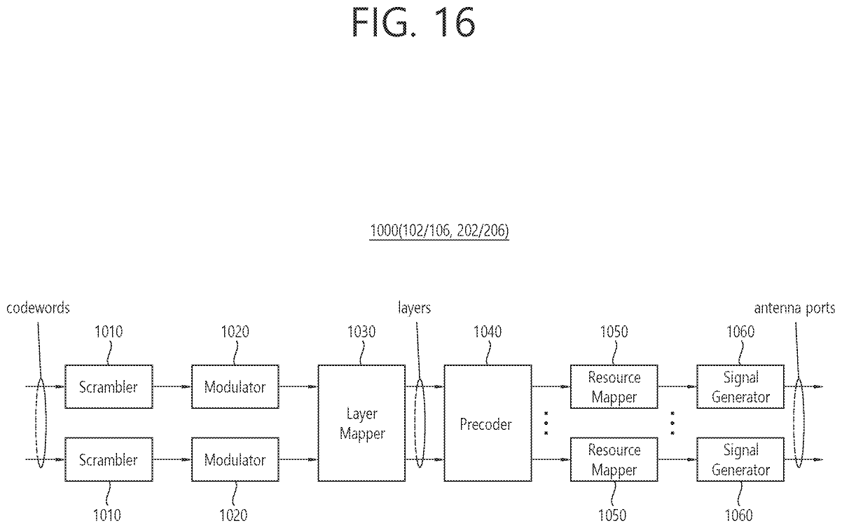

FIG. 16 shows a signal process circuit for a transmission signal, based on an embodiment of the present disclosure. The embodiment of FIG. 16 may be combined with various embodiments of the present disclosure.

Referring to FIG. 16, a signal processing circuit 1000 may include scramblers 1010, modulators 1020, a layer mapper 1030, a precoder 1040, resource mappers 1050, and signal generators 1060. An operation/function of FIG. 16 may be performed, without being limited to, the processors 102 and 202 and/or the transceivers 106 and 206 of FIG. 15. Hardware elements of FIG. 16 may be implemented by the processors 102 and 202 and/or the transceivers 106 and 206 of FIG. 15. For example, blocks 1010 to 1060 may be implemented by the processors 102 and 202 of FIG. 15. Alternatively, the blocks 1010 to 1050 may be implemented by the processors 102 and 202 of FIG. 15 and the block 1060 may be implemented by the transceivers 106 and 206 of FIG. 15.

Codewords may be converted into radio signals via the signal processing circuit 1000 of FIG. 16. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 16. For example, the wireless devices (e.g., 100 and 200 of FIG. 15) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

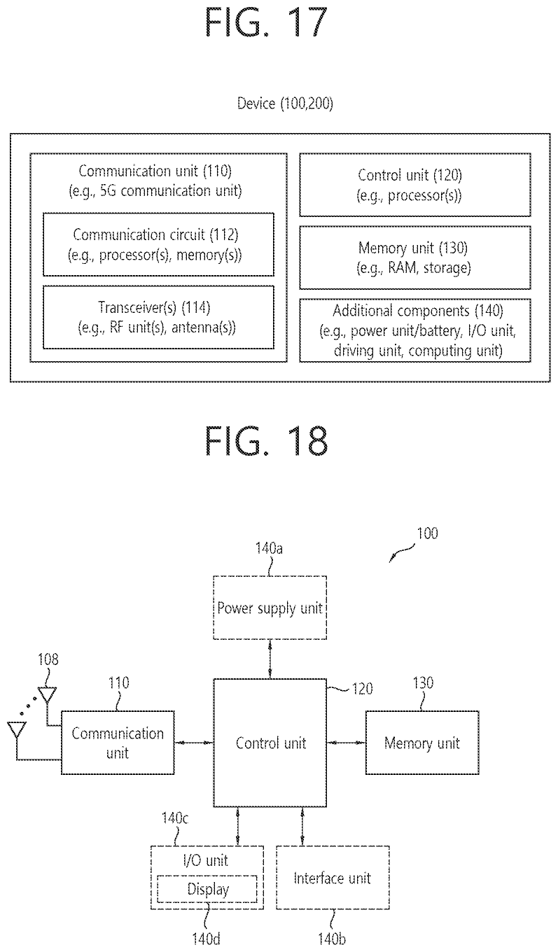

FIG. 17 shows another example of a wireless device, based on an embodiment of the present disclosure. The wireless device may be implemented in various forms according to a use-case/service (refer to FIG. 14). The embodiment of FIG. 17 may be combined with various embodiments of the present disclosure.

Referring to FIG. 17, wireless devices 100 and 200 may correspond to the wireless devices 100 and 200 of FIG. 15 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 15. For example, the transceiver(s) 114 may include the one or more transceivers 106 and 206 and/or the one or more antennas 108 and 208 of FIG. 15. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 14), the vehicles (100b-1 and 100b-2 of FIG. 14), the XR device (100c of FIG. 14), the hand-held device (100d of FIG. 14), the home appliance (100e of FIG. 14), the IoT device (100f of FIG. 14), a digital broadcast terminal, a hologram device, a public safety device, an MTC device, a medicine device, a fintech device (or a finance device), a security device, a climate/environment device, the AI server/device (400 of FIG. 14), the BSs (200 of FIG. 14), a network node, etc. The wireless device may be used in a mobile or fixed place according to a use-example/service.

In FIG. 17, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 17 will be described in detail with reference to the drawings.

FIG. 18 shows a hand-held device, based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. 18 may be combined with various embodiments of the present disclosure.

Referring to FIG. 18, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 17, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

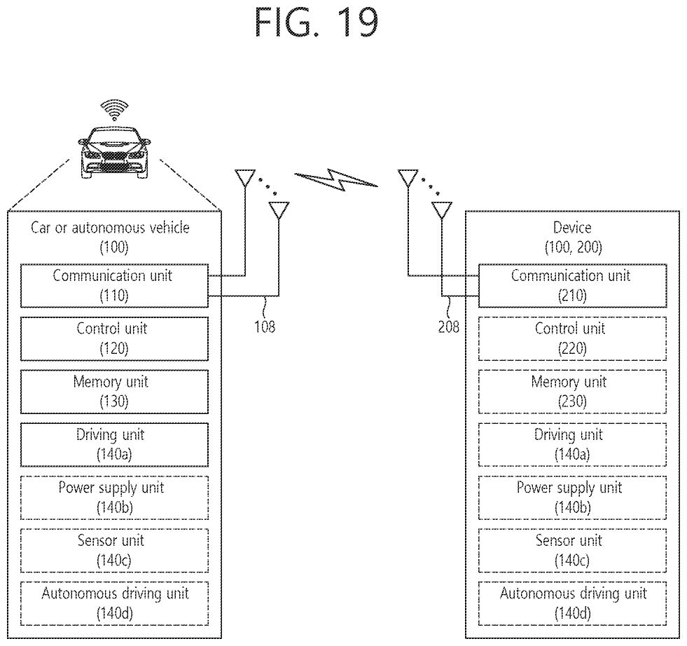

FIG. 19 shows a vehicle or an autonomous vehicle, based on an embodiment of the present disclosure. The vehicle or autonomous vehicle may be implemented by a mobile robot, a car, a train, a manned/unmanned Aerial Vehicle (AV), a ship, etc. The embodiment of FIG. 19 may be combined with various embodiments of the present disclosure.

Referring to FIG. 19, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 17, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The extemal server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1-20. (canceled)

21. A method for performing wireless communication by a first device, the method comprising:
receiving, from a second device, state information;
determining a current driving path and a predicted driving path of the second device, based on the state information;
selecting valid information related to the current driving path and the predicted driving path, among providable information by the first device, based on the current driving path and the predicted driving path;
determining a type related to a transmission of the valid information, based on the current driving path and the predicted driving path; and
transmitting, to the second device, the valid information, based on the determined type related to the transmission.

22. The method of claim 21, wherein the type related to the transmission of the valid information is determined as an aperiodic transmission, based on the valid information being a two-way communication-based information.

23. The method of claim 22, wherein the two-way communication is based on at least one of unicast or groupcast.

24. The method of claim 23, wherein a type related to a transmission of map information is determined as an aperiodic transmission, based on the valid information being the map information related to the current driving path and the predicted driving path of the second device.

25. The method of claim 24, wherein the map information is information excluding map information which is not related to the current driving path and the predicted driving path of the second device from among the providable information.

26. The method of claim 24, further comprising:
determining whether the second device has the map information,
wherein the type related to the transmission of the map information is determined as a one-time transmission, based on the determination that the second device does not have the map information.

27. The method of claim 23, wherein a type related to a transmission of signal information is determined as an aperiodic transmission, based on the valid information being the signal information related to the current driving path and the predicted driving path of the second device.

28. The method of claim 27, wherein the signal information is information excluding signal information which is not related to the current driving path and the predicted driving path of the second device from among the providable information.

29. The method of claim 27, wherein the signal information is information that changes over time, and
wherein the type related to the transmission of the signal information is determined as the aperiodic transmission, based on a change time of the signal information.

30. The method of claim 29, wherein the aperiodic transmission is based on one transmission per the change time of the signal information.

31. The method of claim 29, wherein the aperiodic transmission is based on the transmission of the signal information being stopped before a change of the signal information after the transmission of the signal information.

32. The method of claim 21, wherein the state information includes information related to at least one of a location, a direction, a velocity, or driving intention of the second device.

33. The method of claim 21, wherein the state information is received, from the second device, based on at least one of a cooperative awareness message (CAM) or a basic safety message (BSM).

34. A first device adapted to perform wireless communication, the first device comprising:
at least one transceiver;
at least one processor; and
at least one memory connected to the at least one processor and storing instructions that, based on being executed, cause the first device to perform operations comprising:
receiving, from a second device, state information;
determining a current driving path and a predicted driving path of the second device, based on the state information;
selecting valid information related to the current driving path and the predicted driving path, among providable information by the first device, based on the current driving path and the predicted driving path;
determining a type related to a transmission of the valid information, based on the current driving path and the predicted driving path; and
transmitting, to the second device, the valid information, based on the determined type related to the transmission.

35. The first device of claim 34, wherein the type related to the transmission of the valid information is determined as an aperiodic transmission, based on the valid information being a two-way communication-based information.

36. The first device of claim 35, wherein the two-way communication is based on at least one of unicast or groupcast.

37. The first device of claim 36, wherein a type related to a transmission of map information is determined as an aperiodic transmission, based on the valid information being the map information related to the current driving path and the predicted driving path of the second device.

38. A processing device adapted to control a first device to perform wireless communication, the processing device comprising:
at least one processor; and
at least one memory connected to the at least one processor and storing instructions that, based on being executed, cause the at least one processor to perform operations comprising:
receiving, from a second device, state information;
determining a current driving path and a predicted driving path of the second device, based on the state information;
selecting valid information related to the current driving path and the predicted driving path, among providable information by the first device, based on the current driving path and the predicted driving path;
determining a type related to a transmission of the valid information, based on the current driving path and the predicted driving path; and
transmitting, to the second device, the valid information, based on the determined type related to the transmission.

39. The processing device of claim 38, the type related to the transmission of the valid information is determined as an aperiodic transmission, based on the valid information being a two-way communication-based information.

40. The processing device of claim 38, the two-way communication is based on at least one of unicast or groupcast.
